(19) United States
(12) Patent Application Publication
(10) Pub. No.: US 2004/0146016 A1
(43) Pub. Date: Jul. 29, 2004

(54) Apparatus and method for controlling reverse data rate in a mobile communication system

(75) Inventors: Youn-Sun Kim, Seongnam-si (KR); Hwan-Joon Kwon, Hwaseong-si (KR); Dong-Hee Kim, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/756,716

(22) Filed: Jan. 12, 2004

(30) Foreign Application Priority Data
Jan. 10, 2003 (KR) 1732/2003

(51) Int. Cl. G08C 15/00

(52) U.S. Cl. 370/328; 370/252

(57) ABSTRACT

An apparatus and method for controlling a reverse data rate in a mobile communication system. In a mobile communication system having MSs that transmit reverse data and change reverse data rates based on RCBs received from a BS, and the BS that controls the reverse data rate of each of the MSs, to individually control the reverse data rates of the MSs, the BS generates a global RCB indicating a rate increase or decrease to all MSs within the BS and transmits the global RCB to the MSs. The BS generates dedicated RCBs indicating a rate increase or decrease for the respective MSs and transmits the dedicated RCBs to the MSs, respectively.

### PRIORITY

This application claims priority under 35 U.S.C. § 119 to an application entitled “Apparatus and Method for Controlling Reverse Data Rate in a Mobile Communication System” filed in the Korean Intellectual Property Office on Jan. 10, 2003 and assigned Serial No. 2003-1732, the contents of which are incorporated herein by reference.

### BACKGROUND OF THE INVENTION

1. Field of the Invention

The present invention relates generally to an apparatus and method for controlling a data rate of traffic in a mobile communication system, and in particular, to an apparatus and method for controlling the data rate of reverse traffic.

2. Description of the Related Art

Mobile communication systems are largely divided into voice service only supporting systems and data service only supporting systems. The major example of a mobile communication system supporting only voice service or only data service is CDMA (Code Division Multiple Access). The CDMA system supporting only voice service is based on IS-95.

Mobile communication technology has drastically developed to satisfy user demands for fast and various data transmission services. Accordingly, mobile communication systems have correspondingly evolved to provide a variety of data services. For example, CDMA2000 was proposed to support voice service and high-speed data service simultaneously. 1xEV-DO (Evolution-Data Only) was proposed to support high-speed data service only.

Data transmission is directed from a base station (BS) to a mobile station (MS) or vice versa in a mobile communication system. The BS to MS direction is termed “forward”, and the MS to BS direction is termed “reverse”. Control of reverse data rate in the 1xEV-DO mobile communication system will be described below.

The data rate of a reverse traffic channel starts with 9.6 kbps in the 1xEV-DO mobile communication system. In other words, the maximum reverse data rate available to an MS is 9.6 kbps when a call is initiated. After the call set-up on the reverse link, the reverse data rate is changed under control of a BS. The maximum reverse data rate available to the MS is the current reverse data rate. This maximum reverse data rate is changed due to internal or external factors of the MS.

The case where the maximum reverse data rate is changed due to an external factor will first be addressed. The reverse data rate is changed according to an RAB (Reverse Activity Bit) received from the BS. If the RAB indicates an increase of the reverse data rate, the MS performs a persistence test to determine whether to maintain or increase the current reverse data rate. If the persistence test demonstrates that the reverse data rate is to be increased, it is increased. If the persistence test demonstrates that the reverse data rate is to be maintained, it is maintained. However, if the RAB indicates a decrease of the reverse data rate, the MS performs a persistence test to decide whether to maintain or decrease the current reverse data rate. The MS maintains or decreases the reverse data rate as the persistence test demonstrates. The BS transmits the RAB, which is a 1-bit signal, every 20 ms.

The persistence test is passed or failed according to whether a random number generated is greater than a predetermined number. For an instance, if the MS transmits data at 153.6 kbps and the RAB indicates a data rate increase, the MS performs a persistence test to determine whether to increase the reverse data rate. In the test, the MS generates a random number in a predetermined method and, if the random number is greater than a predetermined number, increases the reverse data rate. However, if the random number is equal to or less than the predetermined number, the MS maintains the reverse data rate.

Due to an internal factor, the MS may change the maximum reverse data rate. There is a case where the MS is not permitted to increase the reverse data rate even if the persistence test allows for a data rate increase. Because each MS receives a data rate limit, CurrentRateLimit from the BS, even if both the RAB and the persistence test indicate a data rate increase, the MS cannot increase the reverse data rate beyond the limit. Therefore, the MS resets the maximum reverse data rate as the data rate limit.

By determining the reverse data rate in the above-described manner, the BS controls the total amount of traffic, which instantly varies. The BS sets the RAB according to the conditions of the instantly varying reverse link, thereby controlling the total reverse traffic generated from a plurality of MSs. This traffic control attempts to control interference proportional to the amount of traffic. In general, if the interference exceeds an acceptable level in a CDMA system, communication is impossible.

As described above, the BS controls the reverse data rate by the 1-bit RAB. However, the RAB is not a dominant factor in determining the actual reverse data rate. The actual reverse data rate depends on the probability-based persistence test as well as the RAB. From a BS's perspective, there is no knowing which MS will change its data rate and controlling interference generated from individual MSs. Therefore, the RAB-based reverse data rate control is not effective in estimating accurate interference from each MS and coping with situations on the reverse link. As a result, the BS may not achieve a maximum reverse system capacity and, if ever, cannot quickly reach the maximum reverse system capacity. Therefore, preferably, the BS needs to control the reverse data rates of MSs individually, precluding the probability-based persistence test.

### SUMMARY OF THE INVENTION

An object of the present invention is to substantially solve at least the above problems and/or disadvantages and to provide at least the advantages described herein below. Accordingly, an object of the present invention is to provide an apparatus and method for individually controlling the data rates of MSs in order to maximize reverse system capacity in a mobile communication system.

Another object of the present invention is to provide an apparatus and method for controlling the data rates of MSs such that a BS quickly reaches an available maximum reverse system capacity.

A further object of the present invention is to provide a data rate controlling apparatus and method in which a BS sets a reverse data rate for each MS efficiently.

The above and other objects are achieved by providing an apparatus and method for controlling a reverse data rate in a mobile communication system, as described in the present invention.

According to one aspect of the present invention, in a mobile communication system having MSs that transmit reverse data and change reverse data rates based on Reverse Control Bits (RCBs) received from a BS, and the BS that controls the reverse data rate of each of the MSs, to individually control the reverse data rates of the MSs, the BS generates a global RCB indicating a rate increase or decrease to all MSs within the BS and transmits the global RCB to the MSs. The BS generates dedicated RCBs indicating a rate increase or decrease for the respective MSs and transmits the dedicated RCBs to the MSs, respectively.

According to another aspect of the present invention, in a mobile communication system having MSs that transmit reverse data and change reverse data rates based on RCBs received from a BS, and the BS that controls the reverse data rate of each of the MSs, an apparatus for individually controlling the reverse data rates of the MSs in the BS includes a controller and a transmitter. The controller generates a global RCB indicating a rate increase or decrease to all MSs within the BS according to the total capacity of the BS and dedicated RCBs indicating a rate increase or decrease for the respective MSs according to the data rates and interference of the MSs. The transmitter transmits the global RCB to all the MSs and transmits the dedicated RCBs to the respective MSs.

According to a further aspect of the present invention, in a method of determining a reverse data rate in an MS that transmits data to a BS and receives a global RCB and a dedicated RCB from the BS, the MS increases a maximum reverse data rate if both the global RCB and the dedicated RCB indicate a rate increase, decreases the maximum reverse data rate if both the global RCB and the dedicated RCB indicate a rate decrease, and maintains the maximum reverse data rate if the global RCB and the dedicated RCB are different.

According to still another aspect of the present invention, in an apparatus for determining a reverse data rate in an MS that transmits data to a BS and receives a global RCB and a dedicated RCB from the BS, an RF module downconverts a frequency of an RF signal received from the BS and despreads the downconverted signal. An RCB position calculator calculates the positions of the global and dedicated RCBs, and outputs RCB position information. A demultiplexer extracts the global RCB and the dedicated RCB from the despread signal according to the RCB position information. A controller receives the global RCB and the dedicated RCB from the demultiplexer, increases a maximum reverse data rate if both the global RCB and the dedicated RCB indicate a rate increase, decreases the maximum reverse data rate if both the global RCB and the dedicated RCB indicate a rate decrease, and maintains the maximum reverse data rate if the global RCB and the dedicated RCB are different.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates transmission of a global RCB and dedicated RCBs in time multiplexing from a BS to individually control maximum reverse data rates according to an embodiment of the present invention;

FIG. 2 illustrates transmission of a global RCB and dedicated RCBs in code multiplexing from a BS according to another embodiment of the present invention;

FIG. 3 is a diagram illustrating the timing of receiving a dedicated RCB and a global RCB transmitted as illustrated in FIG. 1 and determining a reverse data rate in an MS;

FIG. 4 is a flowchart illustrating an operation in the MS for receiving a global RCB and a dedicated RCB and determining its available maximum data rate according to the present invention;

FIG. 5 is a block diagram of a BS transmitter for transmitting a global RCB and dedicated RCBs according to the present invention;

FIG. 6 illustrates RCBs including at least two global RCBs per frame, transmitted by the BS to individually control maximum reverse data rates according to a third embodiment of the present invention;

FIG. 7 is a block diagram of an MS receiver for receiving time-multiplexed global and dedicated RCBs according to the present invention; and

FIG. 8 is a block diagram of a BS transmitter for transmitting global RCBs on an orthogonal channel different from that for dedicated RCBs according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

To individually control reverse data rates, unlike the conventional 1xEV-DO system, each BS must be able to notify each MS of an increase, decrease, or maintenance in its reverse maximum data rate. The individual data rate control is accomplished by transmitting one global RCB (Reverse Control Bit) and as many dedicated RCBs as the number of MSs that receive data service. Each MS determines whether to increase, decrease, or maintain its maximum data rate based on the global RCB common to all MSs and a dedicated RCB for the MS. The global and dedicated RCBs may be transmitted on different channels or a common control channel.

Each BS determines the values of global and dedicated RCBs according to ROT (Rise Over Thermal), a total received signal strength, or a total interference generated, which are measured in the BS. The ROT is defined as the ratio between the total power received from all MSs at a BS receiver and the thermal noise. In the CDMA2000 mobile communication system, when a reverse ROT is 7 dB or higher, the performance of the reverse link is rapidly degraded and normal wireless communication is impossible. The BS can control the ROT to be as approximate to 7 dB as possible but not to exceed 7 dB by appropriately controlling the reverse data rates of MSs that it services, to thereby maximize system capacity. For an example, if an ROT at a particular time is 5 dB, the BS commands an MS that it services to increase the reverse data rate so that the ROT is between 5 dB and 7 dB in the next time period.

Also, the BS determines a rate increment or decrement based on the ROT within its total capacity. If a data rate increase is available within the total capacity, a global RCB is set to indicate increase and if a data rate decrease is required, the global RCB is set to indicate decrease. The BS then determines MSs to select to increase or decrease its reverse data rates based on the ROT. That is, when the BS determines to increase reverse data rate according to the ROT measurement, it then selects MSs of which the data rates are to be increased. The service qualities (QoSs) and current data rates of the MSs are taken into consideration when selecting the MSs for data rate increase. The BS generates dedicated rate control information indicating a data rate increase and transmits it to the MSs, while transmitting dedicated rate control information indicating a data rate maintenance to the other MSs. However, if the BS needs to decrease reverse data rate, it selects MSs of which the data rates are to be decreased in the same manner and transmits dedicated rate control information indicating a data rate decrease to the selected MSs.

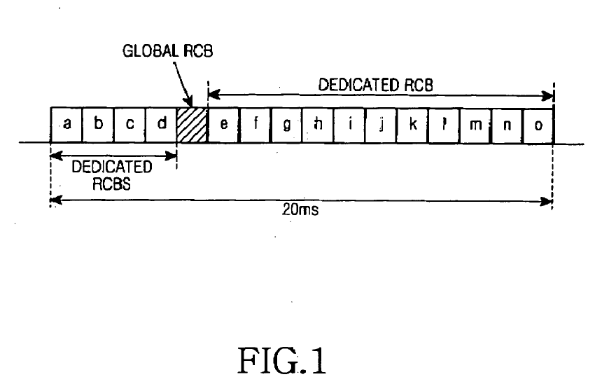

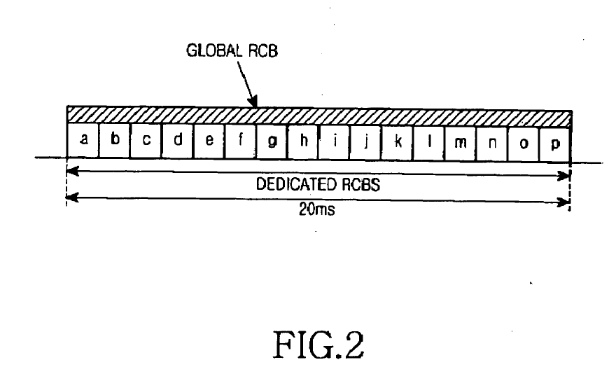

FIG. 1 illustrates transmission of a global RCB and dedicated RCBs in time multiplexing from a BS to individually control maximum reverse data rates according to an embodiment of the present invention. Referring to FIG. 1, the BS simultaneously transmits a dedicated RCB, which is specific to each corresponding MS, and a global RCB that is common to all MSs for a time period 20 ms. The global RCB and the dedicated RCBs are time-multiplexed in FIG. 1. FIG. 2 illustrates transmission of a global RCB and dedicated RCBs in code multiplexing from a BS according to another embodiment of the present invention.

Referring to FIGS. 1 and 2, the BS transmits one global RCB and a plurality of dedicated RCBs for a time period of 20 ms. The global RCB is delivered with transmit power strong enough for all MSs that the BS services to receive, whereas each dedicated RCB is transmitted with transmit power strong enough for a corresponding MS to receive. Because the global RCB is received in all the MSs, it is transmitted at a predetermined time as illustrated in FIG. 1, while it is transmitted with a predetermined code as illustrated in FIG. 2.

Although 15 and 16 dedicated RCBs are illustrated in FIGS. 1 and 2, respectively, the number of dedicated RCBs can be changed according to the number of MSs that transmit data on the reverse link. Dedicated RCBs set for respective MSs are transmitted in predetermined positions to prevent the other MSs from referring to wrong dedicated RCBs. The positions of the dedicated RCBs can be changed every 20 ms by a dedicated RCB position randomization algorithm. While the dedicated RCB and the global RCB are transmitted in every slot (1.25 ms in the present invention) within a 20-ms frame in the embodiment of the present invention, one dedicated RCB or global RCB can be transmitted in every frame.

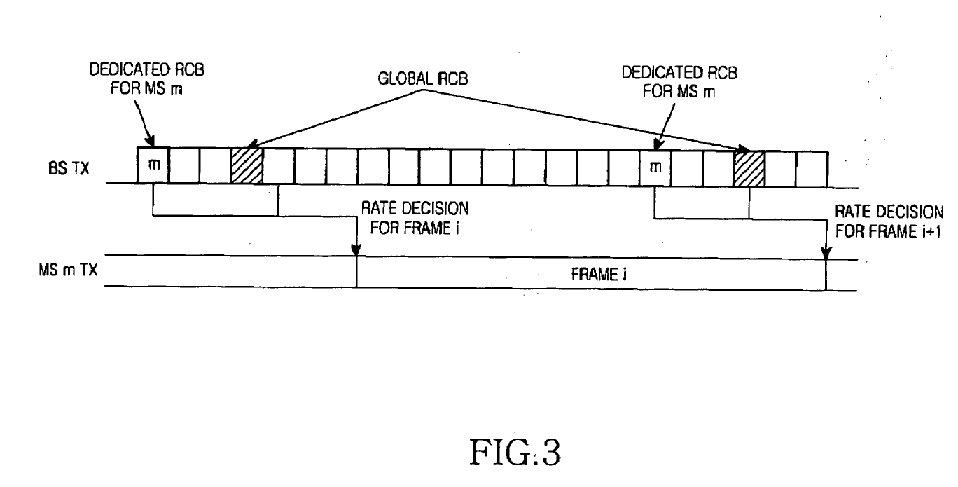

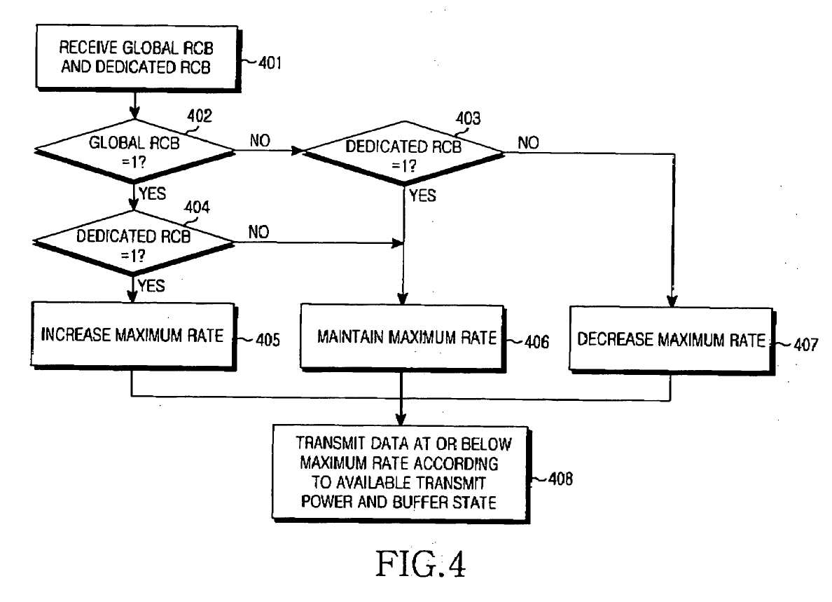

FIG. 3 is a diagram illustrating the timing of receiving a dedicated RCB and a global RCB transmitted as illustrated in FIG. 1 and determining a reverse data rate in an MS. Referring to FIG. 3, the MS refers to the last received global RCB and its dedicated RCB to determine a data rate for an ith frame. Specifically, the MS determines its available maximum data rate using the global and dedicated RCBs in an algorithm illustrated in FIG. 4.

FIG. 4 is a flowchart illustrating an operation in the MS for receiving a global RCB and a dedicated RCB and determining its available maximum data rate according to the present invention. Referring to FIG. 4, the MS needs both the global RCB and the dedicated RCB to determine an available maximum data rate. The MS receives the global and dedicated RCBs in step 401 and determines whether the global RCB is 1 in step 402. If the global RCB is 1, the MS determines whether the dedicated RCB is 1 in step 404. If the dedicated RCB is 1, the MS increases the maximum data rate in step 405. If the dedicated RCB is not 1 in step 404, which implies that the global RCB is different from the dedicated RCB, the MS maintains the current data rate as the maximum data rate in step 406.

However, if the global RCB is not 1 in step 402, the MS determines whether the dedicated RCB is 1 in step 403. If the dedicated RCB is 1 in step 403, which implies that the global RCB is different from the dedicated RCB, the MS maintains the current data rate as the maximum data rate in step 406. If the dedicated RCB is 1, that is, both the global and dedicated RCBs are Os in step 403, the MS decreases the maximum data rate in step 407.

After determining the data rate in step 405, 406, or 407, in step 408 the MS sets the determined maximum data rate or a lower data rate as a final maximum data rate, taking its buffer state into account. The MS then transmits reverse data at the final maximum data rate.

Data rate changes according to global and dedicated RCBs are tabulated below in Table 1.

TABLE 1

| Global RCB | Dedicated RCB | Rate Decision |
|---|---|---|
| 1 | 1 | Maximum rate increase |
| 1 | 0 | Maximum rate maintained |
| 0 | 1 | Maximum rate maintained |
| 0 | 0 | Maximum rate decrease |

Using the global and dedicated RCBs, the BS increases, decreases, or maintains the maximum data rate of MSs individually without the need of transmitting 2 bits to each MS. If N MSs perform reverse communication to a BS, not 2N dedicated RCBs but one global RCB and N dedicated RCBs are required for the BS to individually order the MSs to increase, decrease, or maintain their data rates. The reverse data rate control is accomplished by using (N+1) bits in total. The reduction of bits needed to notify MSs of their maximum data rates in turn reduces interference caused by the RCBs on the forward link.

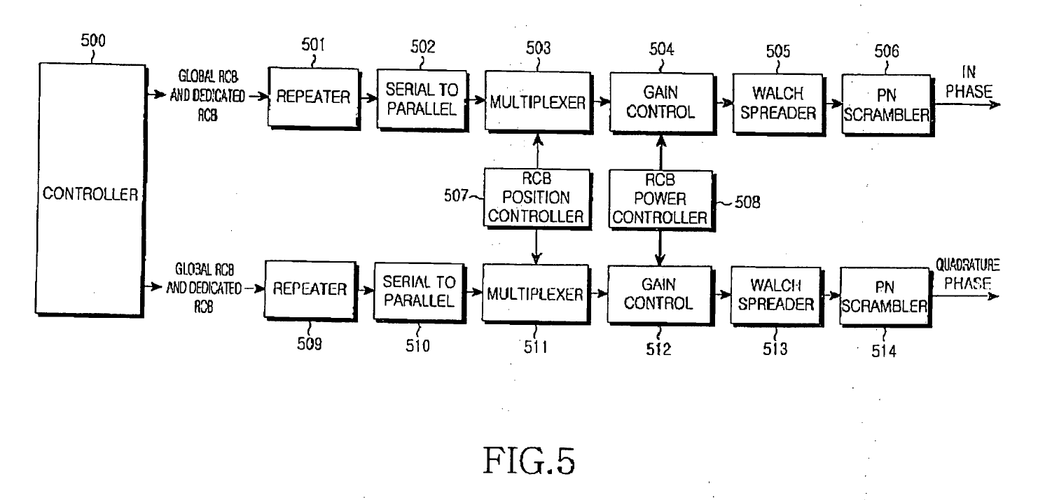

FIG. 5 is a block diagram of a BS transmitter for transmitting a global RCB and dedicated RCBs according to the present invention. Referring to FIG. 5, a controller 500 checks the states of the reverse link and each MS, and determines and generates the global RCB and the dedicated RCBs according to the link and MS states. A first repeater 501 repeats the global and dedicated RCBs a predetermined number of times. A first serial to parallel converter (SPC) 502 converts the repeated RCBs to parallel ones. A first multiplexer (MUX) 503 multiplexes the parallel RCBs under the control of an RCB position controller 507. When time multiplexing as illustrated in FIG. 1, the global RCB must be disposed at a time position known to all MSs. When code multiplexing as illustrated in FIG. 2, a code applied to the global RCB must be known to all the MSs.

A first gain controller 504 increases the transmit power of the global RCB received from the fist MUX 503 under the control of an RCB power controller 508 such that all the MSs can receive the global RCB, because a particular MS needs its dedicated RCB and the global RCB shared among all the MSs that the BS services, as shown in Table 1, to determine its maximum data rate. Also, the first gain controller 504 increases the transmit power of each dedicated RCB such that a corresponding MS can receive the dedicated RCB. A first Walsh spreader 505 spreads the power-controlled RCBs with an orthogonal code. A first PN scrambler 506 scrambles the spread signal with a PN code and outputs the scrambled signal as an in-phase signal.

Function blocks 509 to 514 operate in the same manner as their counterparts 501 to 506, except that the global and dedicated RCBs are transmitted as a quadrature-phase signal. Further, the RCB position controller 507 and the RCB power controller 508 may be incorporated into the controller 500, or implemented as separate devices without the controller 500 as illustrated in FIG. 5.

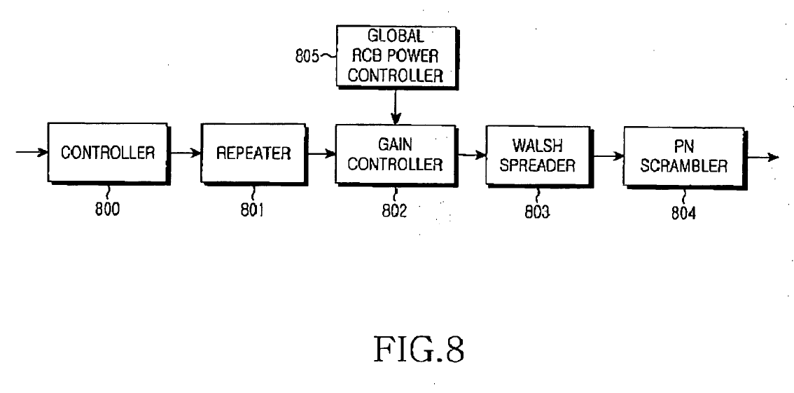

FIG. 8 is a block diagram of a BS transmitter for transmitting a global RCB on a different orthogonal channel from that of dedicated RCBs according to the present invention. Referring to FIG. 8, a controller 800 checks the states of the reverse link and each MS. The controller 800 determines the global RCB according to the MS states and generates it. A repeater 801 repeats the global RCB a predetermined number of times.

A gain controller 802 increases the transmit power of the global RCB according to a power control value received from a global RCB power controller 805 such that all the MSs can receive the global RCB. A Walsh spreader 803 spreads the power-controlled global RCB with a Walsh code known to the BS and the MSs. A PN scrambler 804 scrambles the spread signal with a PN code.

The above-described transmitter is a global RCB transmitter when the dedicated RCBs are time-multiplexed and transmitted on a different orthogonal channel from that of the global RCB. A dedicated RCB transmitter can be designed as illustrated in FIG. 5, except that only dedicated RCBs are applied to the input of the repeaters 501 and 509.

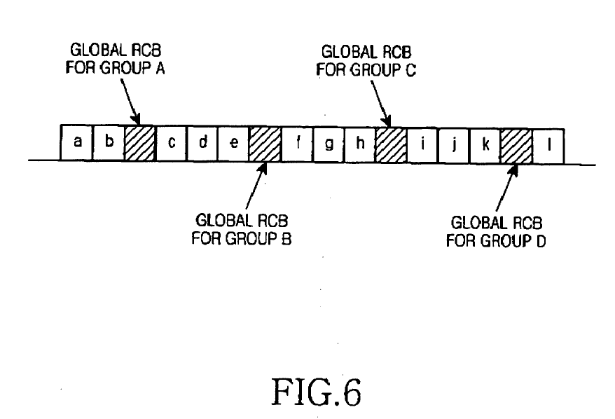

FIG. 6 illustrates RCBs including two or more global RCBs per frame, transmitted by the BS to individually control maximum reverse data rates according to a third embodiment of the present invention. Referring to FIG. 6, the BS transmits four global RCBs in one frame. The four global RCBs are used to control the maximum data rates of MSs in four different groups. For example, if there are 100 MSs that one BS services, they are grouped into four groups A to D, each group including 25 MSs. The MSs in each group determine their maximum data rates using a global RCB corresponding to the group. This method is efficient when reverse data rate is controlled by grouping MSs according to various factors such as service level, distance, and channel environment.

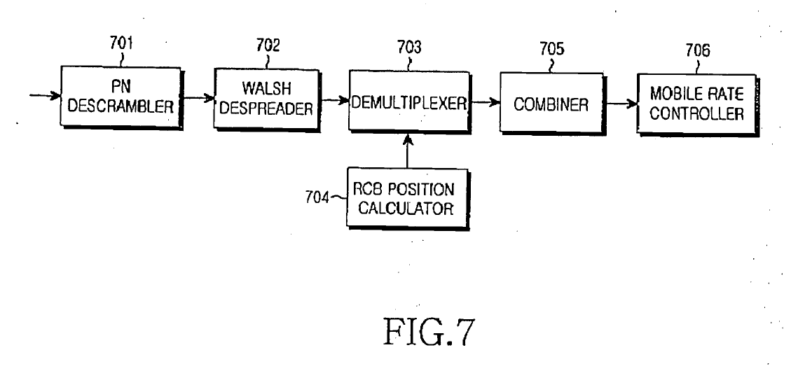

FIG. 7 is a block diagram of an MS receiver for receiving global and dedicated RCBs when a BS transmits the global and dedicated RCBs in time multiplexing according to the present invention. Notably, typical blocks including a block responsible for frequency downconversion for receiving an RF (radio frequency) signal are not shown here.

Referring to FIG. 7, the MS downconverts the frequency of received global and dedicated RCBs. A PN descrambler 701 descrambles the downconverted signal with a PN code. A Walsh despreader 702 despread the descrambled signal with an orthogonal code. A demultiplexer (DEMUX) 703 extracts the global RCB and the dedicated RCB from the despread signal. The BS and the MS gains knowledge of the time positions of the global and dedicated RCBs in a method preset between them.

To detect the positions of the global and dedicated RCBs, an RCB position calculator 704 calculates the positions of the RCBs in the preset method. The DEMUX 703 locates the RCBs according to values received from the RCB position calculator 704. A combiner 705 combines the extracted global RCBs and dedicated RCBs, separately. This operation occurs only when the repeaters 501 and 509 of FIG. 5 repeat the global and dedicated RCBs. Thus, if the transmitter does not repeat the RCBs, the combiner 705 is omitted in the receiver or if the combiner 705 exists, the symbols bypass the combiner 705. A maximum rate controller 706 determines a maximum data rate for the MS using one global RCB and one dedicated RCB received from the combiner 705 by the procedure illustrated in FIG. 4.

If the global and dedicated RCBs are code-multiplexed, a dedicated RCB receiver has the configuration illustrated in FIG. 7, whereas a global RCB receiver is configured with the PN descrambler and the Walsh despreader 702. After orthogonal despreading, the global RCB is applied to the maximum rate controller 706. Because the global RCB is received in code multiplexing with the dedicated RCB, demultiplexing and combining the global RCB is not necessary. The whole configuration of FIG. 7 is used for receiving the dedicated RCB.

In accordance with the present invention as described above, a reverse data rate control is performed feasibly for individual MSs using a reduced number of RCBs. Therefore, a full reverse link utilization is quickly achieved and use efficiency is improved.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of individually controlling reverse data rates in a mobile communication system including mobile stations (MSs) for transmitting reverse data and changing reverse data rates based on rate control bits (RCBs) received from a base station (BS), and the BS for controlling the reverse data rate of the MSs, the method comprising the steps of
generating a global RCB indicating one of a rate increase and a rate decrease to all of the MSs within the BS and transmitting the global RCB to the MSs; and
generating dedicated RCBs indicating one of a rate increase and a rate decrease for individual MSs among the MSs and transmitting the dedicated RCBs to the individual MSs, respectively.

2. The method of claim 1, wherein the global RCB and the dedicated RCBs are time-multiplexed prior to transmission.

3. The method of claim 1, wherein the global RCB and the dedicated RCBs are code-multiplexed prior to transmission.

4. The method of claim 1, wherein the MSs are grouped into a predetermined number of groups and a different global RCB is transmitted to each of the groups.

5. The method of claim 1, wherein the global RCB is determined according to a total capacity of the BS.

6. The method of claim 1, wherein the dedicated RCB for each of the individual MSs is determined according to a data rate and an interference level of the MS.

7. An apparatus for individually controlling reverse data rates in a mobile communication system including mobile stations (MSs) for transmitting reverse data and changing reverse data rates based on rate control bits (RCBs) received from a base station (BS), and the BS for controlling the reverse data rate of the MSs, comprising:
a controller for generating a global RCB indicating one of a rate increase and a rate decrease to the MSs within the BS according to a total capacity of the BS and for generating dedicated RCBs indicating one of a rate increase and a rate decrease for individual MSs among the MSs according to the data rates and an interference level of the MSs; and
a transmitter for transmitting the global RCB to the MSs and transmitting the dedicated RCBs to the respective individual MSs.

8. The apparatus of claim 7, wherein the transmitter time-multiplexes the global RCB and the dedicated RCBs prior to transmission.

9. The apparatus of claim 8, wherein the transmitter includes a position controller for determining positions of the global RCB and the dedicated RCBs in time multiplexing.

10. The apparatus of claim 7, wherein the transmitter code-multiplexes the global RCB and the dedicated RCBs prior to transmission.

11. The apparatus of claim 7, wherein the transmitter comprises a power controller for setting the global RCB to a power enabling the global RCB to reach the MSs, and setting each of the dedicated RCBs to a power enabling the dedicated RCB to reach an individual MS corresponding to the dedicated RCB.

12. The apparatus of claim 10, wherein the transmitter comprises a global RCB transmitter for transmitting the global RCB in code multiplexing and a dedicated RCB transmitter for transmitting the dedicated RCBs in time multiplexing.

13. The apparatus of claim 12, wherein the global RCB transmitter comprises:
a gain controller for multiplying the global RCB by a gain to assign a power to the global RCB enabling the MSs to receive the global RCB;
a spreader for Walsh-spreading the gain-controlled global RCB and orthogonally scrambling the Walsh-spread global RCB; and
an RF (Radio Frequency) transmitter for upconverting a frequency of the scrambled signal to an RF signal and transmitting the RF signal to the MSs.

14. The apparatus of claim 13, wherein the global RCB transmitter further comprises a repeater for repeating the global RCB a predetermined number of times and outputting the repeated global RCBs to the gain controller.

15. A method of determining a reverse data rate in a mobile station (MS) that transmits data to a base station (BS) and receives a global rate control bit (RCB) and a dedicated RCB from the BS, comprising the steps of:
increasing a maximum reverse data rate if both the global RCB and the dedicated RCB indicate a rate increase;
decreasing the maximum reverse data rate if both the global RCB and the dedicated RCB indicate a rate decrease; and
maintaining the maximum reverse data rate if the global RCB and the dedicated RCB are different.

16. The method of claim 15, wherein the step of increasing the maximum reverse data rate comprises setting a rate limit that is set by the BS as the maximum reverse data rate, if the maximum reverse data rate exceeds the rate limit.

17. An apparatus for determining a reverse data rate in a mobile station (MS) that transmits data to a base station (BS) and receives a global rate control bit (RCB) and a dedicated RCB from the BS, comprising:
an RF (Radio Frequency) module for downconverting a frequency of an RF signal received from the BS and despreading the downconverted signal;
an RCB position calculator for calculating positions of the global and dedicated RCBs and outputting RCB position information;
a demultiplexer for extracting the global RCB and the dedicated RCB from the despread signal according to the RCB position information; and
a controller for receiving the global RCB and the dedicated RCB from the demultiplexer, increasing a maximum reverse data rate, if both the global RCB and the dedicated RCB indicate a rate increase, decreasing the maximum reverse data rate, if both the global RCB and the dedicated RCB indicate a rate decrease, and maintaining the maximum reverse data rate if the global RCB and the dedicated RCB are different.

18. The apparatus of claim 17, further comprising a combiner for combining global RCB symbols and dedicated RCB symbols received from the demultiplexer into the global RCB and the dedicated RCB, separately, if the BS repeats the global RCB and the dedicated RCB prior to transmission to the MS.

19. A method of determining a reverse data rate in a mobile station (MS) that transmits data to a base station (BS) and receives a global rate control bit (RCB) and a dedicated RCB from the BS, comprising the steps of:
increasing a maximum reverse data rate if one of the global RCB and the dedicated RCB indicates a rate increase; and
decreasing the maximum reverse data rate if one of the global RCB and the dedicated RCB indicates a rate decrease.

20. The method of claim 19, wherein the MS neglects the dedicated RCB if the dedicated RCB is not assigned for the MS.
